(19) United States
(12) Patent Application Publication
(10) Pub. No.: US 2011/0273282 A1
(43) Pub. Date: Nov. 10, 2011

(54) HEADLAMP LIGHT SOURCE LIGHTING APPARATUS AND COMMUNICATION APPARATUS

(76) Inventor: Takashi Ohsawa, Tokyo (JP)

(21) Appl. No.: 13/144,141

(22) PCT Filed: Nov. 4, 2009
(86) PCT No.: PCT/JP2009/005842

§ 371 Date: Jul. 12, 2011

(30) Foreign Application Priority Data
Feb. 25, 2009 (JP) 2009-042408

(51) Int. Cl. B60Q 11/00; B60Q 1/02; B60Q 1/04

(52) U.S. Cl. 340/458; 362/464; 315/82

(57) ABSTRACT

Lighting apparatus 100 lights a light source 2 of a headlamp, and includes: a connection terminal 113 to which a abnormality notification apparatus 200 is connected; a notification signal output unit for outputting a notification signal relating to a condition of the light source 2 and/or a condition of the light source lighting apparatus 100 to the abnormality notification apparatus 200 via the connection terminal 113; and a communication signal output unit for outputting a communication signal having a different signal form to the notification signal to an external communication apparatus 300, from the connection terminal 113. Therefore the notification of an abnormality relating to the light source 2 and/or the light source lighting apparatus 100 and the communication with an external communication apparatus 300 can be performed using a single connection terminal 113.

### TECHNICAL FIELD

The present invention relates to a headlamp light source lighting apparatus for lighting a light source of a headlamp, a notification apparatus corresponding to the headlamp light source lighting apparatus, and a communication apparatus corresponding to the headlamp light source lighting apparatus, and more particularly to signal input and output between the headlamp light source lighting apparatus and a separate external device.

### BACKGROUND ART

Bright, long-lived discharge lamps and LEDs (Light Emitting Diodes) have come into widespread use as light sources for vehicle-installed headlamps in place of conventional halogen bulbs, and in recent years, sophisticated headlamps having additional functions such as an AFS (Advance Front Lighting System) and DRL (Daytime Running Lamp) have appeared. Examples of these sophisticated headlamps include a headlamp having a function for notifying a driver of an abnormal condition in the light source of the headlamp or a headlamp light source lighting apparatus, and a headlamp that communicates with an external communication apparatus to exchange information therewith.

Examples of apparatuses applied to a headlamp having a function for notifying the driver of an abnormal condition include an apparatus that detects a deterioration condition in a light source from a current flowing through the light source and a voltage applied to the light source and displays the detected condition as an abnormality (Patent Document 1), and an apparatus that notifies the driver of an abnormality in an in-vehicle device (Patent Document 2).

### PRIOR ART DOCUMENTS

### Patent Documents

Patent Document 1: Japanese Patent Application Publication No. H10-69989
Patent Document 2: Japanese Patent Application Publication No. 2000-6736

However, to notify the driver of an abnormality in the light source or the headlamp light source lighting apparatus and transmit information through communication with an external apparatus, an apparatus for providing notification of the abnormality in the headlamp light source lighting apparatus and an apparatus with which communication is performed must be connected. Accordingly, a connection terminal for connecting the abnormality notification apparatus and a connection terminal for connecting the apparatus to be communicated must both be provided in the headlamp lighting apparatus.

Hence, the present invention proposes a headlamp light source lighting apparatus capable of providing notification of an abnormality in a light source and/or the light source lighting apparatus and communicating with an external apparatus using a single connection terminal.

### Means for Solving the Problem

A headlamp light source lighting apparatus according to the present invention lights a light source of a headlamp, and includes: a connection terminal to which a first apparatus is connected; a notification signal output unit for outputting a notification signal relating to a condition of the light source and/or a condition of the light source lighting apparatus to the first apparatus via the connection terminal; and a communication signal output unit for outputting a communication signal having a different signal form to the notification signal to a second apparatus that is different to the first apparatus, from the connection terminal.

### Effect of the Invention

According to the present invention, the notification signal and the communication signal having a different signal form to the notification signal are output from an identical output terminal, and therefore notification of an abnormality relating to the light source and/or the light source lighting apparatus and communication with an external communication apparatus can be performed using a single connection terminal.

### BRIEF DESCRIPTION OF THE DRAWINGS

FIG. 1 is a circuit diagram showing a headlamp lighting system according to an embodiment of this application;

FIG. 2 is a waveform diagram showing an output signal level of a lighting apparatus 100 according to an embodiment of this application;

FIG. 3 is a circuit diagram showing a configuration of a determination circuit 203 according to an embodiment of this application;

FIG. 4 is a circuit diagram showing a headlamp lighting system according to another embodiment of this application;

FIG. 5 is a constitutional diagram showing a configuration of a determination circuit 203a according to another embodiment of this application;

FIG. 6 is a view showing the content of a determination made by a voltage level determination circuit 600 according to another embodiment of this application;

FIG. 7 is a circuit diagram showing a headlamp lighting system according to another embodiment of this application;

FIG. 8 is a waveform diagram showing an output signal level of a lighting apparatus 100b according to another embodiment of this application;

FIG. 9 is a circuit diagram showing a headlamp lighting system that includes the lighting apparatus 100b having a constant current output circuit configuration, according to another embodiment of this application;

FIG. 10 is a circuit diagram showing a headlamp lighting system that includes the lighting apparatus 100b having a constant voltage output circuit configuration, according to another embodiment of this application;

FIG. 11 is a circuit diagram showing a headlamp lighting system according to another embodiment of this application; and

FIG. 12 is a view showing the content of a determination made by a voltage level determination circuit 600c according to another embodiment of this application.

### BEST MODE FOR CARRYING OUT THE INVENTION

### Embodiment 1

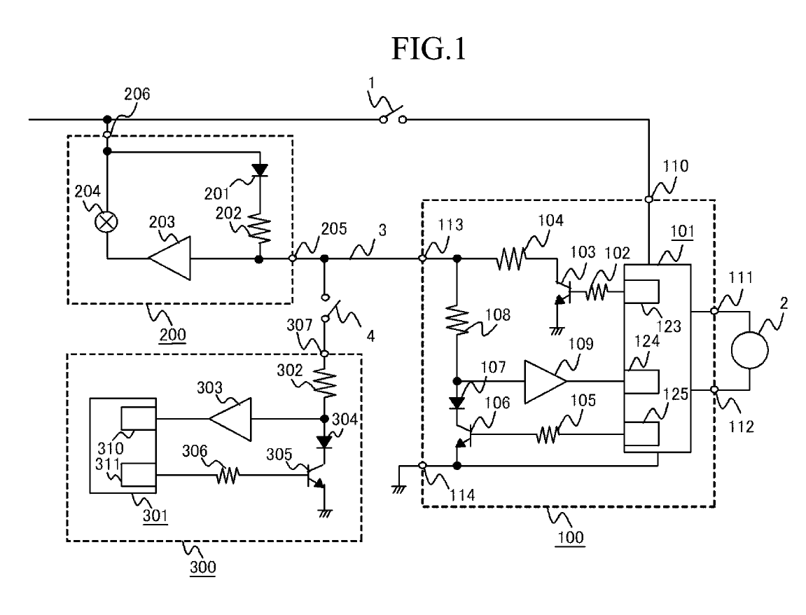

FIG. 1 is a circuit diagram showing a lighting apparatus 100, an abnormality notification apparatus 200, and an external communication apparatus 300 according to Embodiment 1, and connection relationships between these apparatuses. The lighting apparatus 100 and the abnormality notification apparatus 200 together constitute a headlamp lighting system.

The lighting apparatus 100 performs lighting control on a light source 2 and outputs a notification signal and a communication signal to the abnormality notification apparatus 200 and the external communication apparatus 300. The abnormality notification apparatus 200 notifies a driver of an abnormal condition in the light source 2 and/or the lighting apparatus 100 by lighting an alarm lamp 204 on the basis of the notification signal output by the lighting apparatus 100. The external communication apparatus 300 is connected to the lighting apparatus 100 by a connection SW 4 via a signal line 3, and performs processing upon reception of the communication signal output by the lighting apparatus 100. The external communication apparatus 300 is, for example, an inspection apparatus (a diagnosis) that is connected during an inspection of the light source 2 and the lighting apparatus 100 in order to read and display setting information, abnormality information, and so on stored in the lighting apparatus 100. The lighting apparatus 100 and the abnormality notification apparatus 200 are both operated by power supplied from a power supply (not shown) and power is supplied to the lighting apparatus 100 in particular via a power supply SW 1. The constitutions of the lighting apparatus 100, the abnormality notification apparatus 200, and the external communication apparatus 300 will be described below.

The lighting apparatus 100 is constituted by a control circuit 101, a resistor 102, a transistor 103, a resistor 104, a resistor 105, a transistor 106, a diode 107, a resistor 108, a comparator 109, and connection terminals 110 to 114.

The control circuit 101 is connected to the light source 2 via the connection terminals 111 and 112. Further, the control circuit 101 is connected to the power supply via the connection terminal 110 and grounded via the connection terminal 114. An alarm output unit 123 of the control circuit 101 is connected to a base of the transistor 103 via the resistor 102. The alarm output unit 123, the resistor 102, the transistor 103, and the resistor 104 together constitute a notification signal output unit. A collector of the transistor 103 is connected to the connection terminal 113 (output terminal) via the resistor 104. A reception unit 124 of the control circuit 101 is connected to the comparator 109. The comparator 109 serves as a communication signal input unit for identifying the communication signal from the external communication apparatus 300. A transmission unit 125 of the control circuit 101 is connected to a base of the transistor 106 via the resistor 105. A collector of the transistor 106 is connected to the connection terminal 113 via the diode 107 and the resistor 108. The transmission unit 125, the resistor 105, the transistor 106, the diode 107, and the resistor 108 together constitute a communication signal output unit.

The abnormality notification apparatus 200 is constituted by a diode 201, a resistor 202, a determination circuit 203, the alarm lamp 204, and connection terminals 205 and 206.

The terminal 205 for inputting is connected to the connection terminal 113 of the lighting apparatus 100 via the signal line 3. An input unit of the determination circuit 203 is connected to the terminal 205 and connected to a power supply (not shown) via the resistor 202, the diode 201, and the connection terminal 206. An output unit of the determination circuit 203 is connected to the connection terminal 206 via the alarm lamp 204. Hereafter, a voltage between the diode 201 and the resistor 202 will be referred to as an IG reference voltage.

The alarm lamp 204 is, for example, a lamp provided on an instrument panel of a driving seat, and is lit on the basis of an output from the determination circuit 203 to notify the driver of the occurrence of an abnormality in the light source 2 and/or the lighting apparatus 100.

The external communication apparatus 300 is constituted by a communication circuit 301, a resistor 302, a comparator 303, a diode 304, a transistor 305, a resistor 306, and a connection terminal 307.

The connection terminal 307 is connected to the signal line 3 via the connection SW 4. The comparator 303 is connected to the connection terminal 307 via the resistor 302. A reception unit 310 of the communication circuit 301 is connected to the comparator 303. A transmission unit 311 of the communication circuit 301 is connected to a base of the transistor 305 via the resistor 306. A collector of the transistor 305 is connected to the connection terminal 307 via the diode 304 and the resistor 302.

Next, respective operations of the lighting apparatus 100, the abnormality notification apparatus 200, and the external communication apparatus 300 will be described.

The control circuit 101 of the lighting apparatus 100 is operated by power supplied from a power supply connected thereto via the connection terminal 110 to perform lighting control on the light source 2.

The alarm output unit 123 of the control circuit 101 switches the transistor 103 ON and OFF by outputting a rectangular wave constituted by 0 V and 5 V. A voltage change generated by switching the transistor 103 ON and OFF is output as the notification signal.

Examples of the information provided by the notification signal include information indicating that the lighting apparatus 100 is operating normally, information indicating that the light source 2 is flickering, information indicating that a short circuit has occurred between the connection terminals 111, 112, and so on. The control circuit 101 includes a detection unit for detecting a voltage and/or a current of the light source 2, and a determination unit for determining the condition of the light source 2 from an output of the detection unit. On the basis of an output of the determination unit, the control circuit 101 controls the notification signal to be output by the alarm output unit 123.

When a short circuit occurs between the connection terminals 111, 112, for example, the voltage decreases greatly and the current increases greatly. Accordingly, the determination unit determines that a short circuit has occurred between the connection terminals 111, 112 and outputs a determination result to the alarm output unit 123. On the basis of the output of the determination unit, the alarm output unit 123 outputs a notification signal (described below) indicating a short circuit.

Further, when a discharge lamp used as the light source 2 is AC-lit and the life of the discharge lamp draws to an end, the discharge lamp may die out at a polarity switching point where a flowing current value reaches zero. In the event where the discharge lamp dies out, an applied voltage rises while the flowing current remains at zero; thus, although the lighting apparatus 100 relights the discharge lamp, the extinction and lighting of the discharge lamp at this time is observed as flickering. Therefore, after the flowing current falls to zero and the applied voltage is in a high state due to the dying-out of the discharge lamp, an igniter pulse for relighting is generated to light the discharge lamp, which leads to a predetermined voltage and a predetermined current thereof; such behaviors of unique voltage and/or current upon relighting of the discharge lamp are detected, and thereby the determination unit determines that the discharge lamp is flickering and outputs a determination result to the alarm output unit 123. On the basis of the output of the determination unit, the alarm output unit 123 outputs a notification signal, to be described below, indicating discharge lamp flickering.

The discharge lamp may also flicker when gas in the discharge lamp escapes or a pair of electrodes deteriorates, causing a disturbance in the flowing current, due to aging deterioration of the discharge lamp. When a disturbance occurs in the flowing current, the determination unit determines that the discharge lamp is flickering due to a current disturbance, and outputs a determination result to the alarm output unit 123.

As described above, the lighting apparatus 100 includes the detection unit for detection the applied voltage and/or the flowing current of the light source 2, the determination unit for determining the condition of the light source 2 and/or the lighting apparatus 100 itself on the basis of the detected voltage and/or current, and the alarm output unit 123 for outputting a notification signal on the basis of the determination result from the determination unit. Hence, the external abnormality notification apparatus 200 can be notified of the condition of the light source 2 and/or the lighting apparatus 100.

The reception unit 124 of the control circuit 101 receives a signal output by the comparator 109. The transmission unit 125 of the control circuit 101 switches the transistor 106 ON and OFF by outputting a rectangular wave constituted by 0 V and 5 V. The voltage change because of switching ON and OFF of the transistor 106 is output as the communication signal. Examples of the information transmitted by the communication signal include input information and output information such as the following. Note that here, input information is information transmitted to the lighting apparatus 100 from the external communication apparatus 300, while output information is information transmitted to the external communication apparatus 300 from the lighting apparatus 100.

A first example of the input information is an adjustment value of an output power of the lighting apparatus 100. Variation exists in characteristics of the light source 2 attached to the headlamp, and it may therefore be necessary to adjust the output power in accordance with the characteristics of the attached light source 2 during lighting. In this case, a plurality of output characteristics corresponding to the characteristics of the light source 2 must be prepared in the lighting apparatus 100. Hence, by way of the external communication apparatus 300, the lighting apparatus 100 is notified of an adjustment value of the output power corresponding to the light source 2 attached to the head lamp via a communication signal to be set therein, and thereby lighting control can be performed in accordance with the light source 2.

A second example of the input information is information such as an emission color and a luminous efficiency of the connected light source 2. When an LED is used as the light source 2, the LED can be lit in a predetermined emission color and at a predetermined light emission amount by adjusting the emission color of the LED based on a peak current thereof: slightly increasing an average current in an LED having low luminous efficiency, slightly reducing the average current in an LED having high luminous efficiency, and so on. Hence, by way of the external communication apparatus 300, the lighting apparatus 100 is notified of information such as the emission color and the luminous efficiency of the light source 2 to be set therein, and thereby lighting control can be performed on the light source 2 under conditions corresponding to the predetermined emission color and light emission amount.

A third example of the input information is input information relating to dimmed lighting such as a DRL (Daytime Running Lamp). During DRL, the light source 2 is lit in a dimmed condition in comparison with evening lighting, but the degree of dimming is preferably adjusted in accordance with the type of headlamp to which the light source 2 is attached and the vehicle type. Hence, by way of the external communication apparatus 300, the lighting apparatus 100 is notified of input information relating to dimmed lighting to be set therein, and thereby the degree of dimming can be adjusted in accordance with the subject to which the light source 2 is applied.

Examples of the output information include abnormality information relating to the voltage of the light source 2, abnormality information relating to flickering of the light source 2, information relating to deterioration of the light source 2, information relating to a lighting time, and so on. When a discharge lamp is used as the light source 2, deterioration of the discharge lamp can be determined from the lighting conditions in the past of the discharge lamp. For example, when an electrode of the discharge lamp deteriorates, an inter-electrode distance increases, which leads to an increase in the voltage of the discharge lamp. Hence, when information in which the voltage of the discharge lamp is measured and stored in a storage unit is obtained as the output information by the external communication apparatus 300, it can be checked whether the electrode is deteriorated or not. Further, when the end of the life of the discharge lamp draws near, the discharge lamp may die out, and as a result, the discharge lamp may flicker. Therefore, information indicating the number of extinctions and the occurrences of flickering is stored in the storage unit; with this, it can be determined whether the life of the discharge lamp draws to an end. Also, deterioration of the discharge lamp can be determined by storing in the storage unit the values of fluctuated flowing currents in the events where the gas in the discharge lamp escapes and/or where the pair of electrodes deteriorate due to aged deterioration of the discharge lamp, which causes the fluctuation in the flowing currents. Furthermore, by storing a cumulative lighting time of the discharge lamp, a standard can be set for deterioration of the electrodes and so on of the discharge lamp. As described above, when information relating to the light source 2 is stored in the lighting apparatus 100, and is obtained by way of the external communication apparatus 300, information such as the deterioration condition of the light source 2 can be obtained.

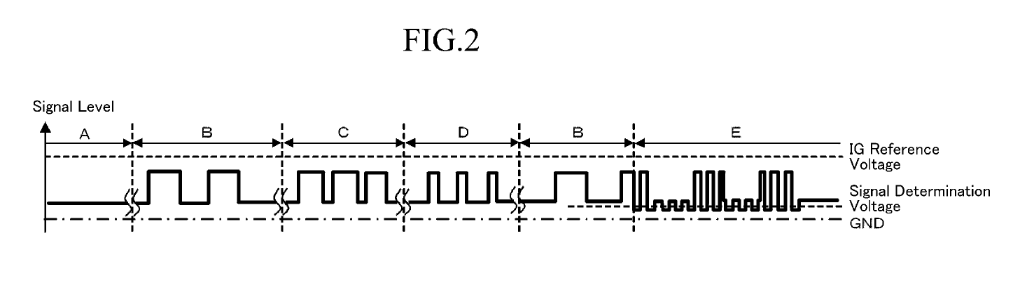

A signal line extending from the resistor 108 is joined to a signal line linking the connection terminal 113 and the resistor 104. Further, the alarm signal output unit 123 and the transmission unit 125 controlled by the control circuit 101 may output the notification signal and the communication signal at the same period of time. In this manner, the notification signal and the communication signal are superimposed by a superimposing unit including the control circuit 101 and a circuit configuration formed by joining the two signal lines, and as a result, an output signal including the superimposed notification signal and communication signal is output from the connection terminal 113 to the abnormality notification apparatus 200 and the external communication apparatus 300. The output signal of the lighting apparatus 100 will now be described. FIG. 2 is a waveform diagram showing an example of output signal levels (signal voltages). The ordinate in the drawing shows the signal level. The IG reference voltage and a GND value are shown on the ordinate as representative values.

When the power supply of the lighting apparatus 100 is OFF, no signal is output from the lighting apparatus 100, and therefore the output signal level takes a fixed low voltage value (region A). When the lighting apparatus 100 begins to operate, the notification signal is generated in response to the output of the alarm output unit 123 of the control circuit 101, and as a result, the output signal level changes. When the light source 2 is lit normally, the output signal forms a rectangular wave having a Duty of ½ (region B). When flickering occurs in the light source 2, the output signal forms a rectangular wave having a Duty of ⅔ (region C). When a short circuit occurs, the output signal forms a rectangular wave having a Duty of ⅓ (region D).

When the communication signal is generated in accordance with the output of the transmission unit 125 of the control circuit 101, the communication signal is superimposed onto the notification signal. When the transistor 106 is switched ON in accordance with the output of the transmission unit 125, the connection terminal 113 is grounded via the resistor 108 and the diode 107, and therefore the output signal level decreases to the vicinity of GND. Hence, the output signal onto which the communication signal is superimposed decreases to the vicinity of GND while the transistor 106 is ON, and rises to the voltage of the rectangular wave generated by the notification signal while the transistor 106 is OFF (region E).

In this manner, when the signal level of the communication signal is set to be lower than the signal level of the notification signal, identification of the signal can be performed easily. For example, when a low level side voltage of the rectangular wave of the notification signal is set at ⅓ or more of the IG reference voltage (a signal identification voltage) and also a low level side voltage of the rectangular wave of the communication signal is set at a lower value than ⅓ of the IG reference voltage, the lighting apparatus 100 can determine whether or not the communication signal has been input by detecting in the comparator 109 of the lighting apparatus 100 whether or not the voltage of the connection terminal 113 has fallen to or below ⅓ of the IG reference voltage (the signal identification voltage). As a result, a response to a communication operation can be initiated without performing a switching operation other than the input operation. Note that an input signal can be identified by performing a similar operation in the comparator 303 of the external communication apparatus 300.

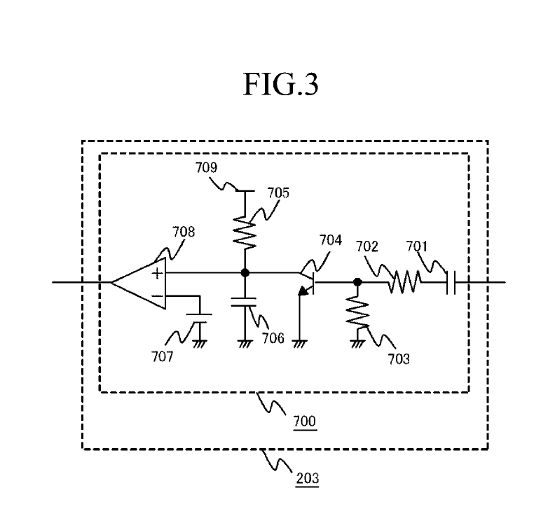

The determination circuit 203 of the abnormality notification apparatus 200 determines whether or not the input notification signal is a rectangular wave. FIG. 3 is a circuit diagram showing a configuration of the determination circuit 203. The determination circuit 203 is constituted by a rectangular wave determination circuit 700 for determining whether or not an input signal is a rectangular wave.

The rectangular wave determination circuit 700 is constituted by a capacitor 701, a resistor 702, a resistor 703, a transistor 704, a resistor 705, a capacitor 706, a power supply 707, a comparator 708, and a power supply 709, wherein the capacitor 701, the resistor 702, and the resistor 703 constitute a differentiating circuit and the capacitor 706 is used as a timer.

An operation of the rectangular wave determination circuit 700 will be described below with differentiating between a case in which the lighting apparatus 100 is normal and a case in which an abnormality occurs.

When the lighting apparatus 100 is operating normally, the signal input into the rectangular wave determination circuit 700 is a rectangular wave. The differentiating circuit constituted by the capacitor 701, the resistor 702, and the resistor 703 performs differentiation on the input signal to detect an edge of the rectangular wave. The differentiating circuit is connected to a base of the transistor 704, and the transistor 704 is switched ON by the differentiating circuit from the edge of the rectangular wave throughout a period corresponding to a time constant of the differentiating circuit.

The capacitor 706 is charged by the power supply 709 via the resistor 705 while the transistor 704 is OFF, and when the transistor 704 is switched ON, a charge of the capacitor 706 is discharged. When a rectangular wave is input into the rectangular wave determination circuit 700, the transistor 704 is switched ON at intervals corresponding to a period of the rectangular wave, and therefore the capacitor 706 is discharged at fixed intervals; thus, a terminal voltage of the capacitor 706 does not rise above a voltage of the power supply 707, for example 3V. Accordingly, an L value (0 V) indicating that a rectangular wave has been input is output from the comparator 708, and thus it can be determined that the input signal is a rectangular wave.

When the lighting apparatus 100 is not operating normally, on the other hand, a rectangular wave is not input into the rectangular wave determination circuit 700. In this case, no edge exists, and therefore the differentiating circuit does not operate and the transistor 704 is not switched ON. As a result, the terminal voltage of the capacitor 706 rises to 5 V, for example, and therefore an H value (5 V, for example) indicating that the rectangular wave has been stopped is output from the comparator 708. Thus it can be determined that the rectangular wave has been stopped.

The rectangular wave determination circuit 700 performs determinations in the manner described above, and therefore, when it is ensured that the rectangular wave notification signal is output continuously from the lighting apparatus 100 during the normal operation of the lighting apparatus 100, an abnormality can be detected by the abnormality notification apparatus 200 in a case where an abnormality occurs in the lighting apparatus 100 to terminate the output of the notification signal.

Next, an operation in which the external communication apparatus 300 and the lighting apparatus 100 are connected will be described. When the external communication apparatus 300 is connected to the lighting apparatus 100 via the connection SW 4, the external communication apparatus 300 outputs a request signal (communication signal) to the lighting apparatus 100 requesting the outputs of lighting control information relating to the light source 2 and/or information relating to the condition of the light source 2. This request signal is output by a request signal output unit (communication signal output unit) constituted by the transmission unit 311, the resistor 306, the transistor 305, the diode 304, and the resistor 302.

The request signal output from the external communication apparatus 300 is detected by the reception unit 124 in the control unit 101 of the lighting apparatus 100. Having detected the request signal, the control unit 101 instructs the transmission unit 125 to control the transistor 106 from which the communication signal is output to the external communication apparatus 300. Having received this instruction from the control unit 101, the transmission unit 125 controls the transistor 106, whereby the output of the communication signal from the lighting apparatus 100 to the external communication apparatus 300 is started.

The communication signal output from the lighting apparatus 100 is detected by the comparator 303 of the external communication apparatus 300. The comparator 303 serves as a communication signal input unit for identifying the communication signal output from the lighting apparatus 100. The communication signal identified by the comparator 303 is input into the reception unit 310 of the communication circuit 301. The communication circuit 301 receives the communication signal and controls a notification unit (not shown) to notify an inspector of the lighting control information relating to the light source 2 and/or the information relating to the condition of the light source 2.

The control unit 301 of the external communication apparatus 300 also functions as an operating unit; thus, the external communication apparatus 300 stores or sets the lighting control information relating to the light source 2 and/or the information relating to the condition of the light source 2 in the lighting apparatus 100 via the communication signal output from the communication signal output unit.

In a lighting apparatus having a basic wiring configuration that is considered similar to a configuration in which two halogen lamp-lighting power supply lines are connected, it is problematic in the design to increase even a single new abnormality notification signal line, and it may therefore be difficult in the design to increase the two of an abnormality notification output terminal and a communication terminal for communicating with an external communication apparatus. In the lighting apparatus 100 according to Embodiment 1 described above, however, the abnormality notification signal line and connection terminal for providing notification of an abnormality in the lighting apparatus 100 and the communication signal line and connection terminal for communicating with the external communication apparatus are shared, and the communication signal is superimposed on the notification signal. Hence, there is no need to provide a signal line and a connection terminal dedicated to communication, and therefore a reduction of the difficulty in the design can be achieved. Furthermore, the constitution of the lighting apparatus 100 can be simplified, which enables a low-cost apparatus.

Further, an amplitude of the signal voltage of the notification signal and an amplitude of the signal voltage of the communication signal are set at different voltages, and therefore, even when the two signals are superimposed in the shared connection terminal 113, the signals can be identified easily in the lighting apparatus 100, abnormality notification apparatus 200, and external communication apparatus 300.

Furthermore, since the low level side voltage of the communication signal is set at a lower voltage than the low level side voltage of the notification signal, there is no need to provide complicated circuits for interior initialization and self-diagnosis communication; as a result, the configuration of the lighting apparatus 100a can be simplified, which enables a low-cost apparatus.

Moreover, since the resistor 104 is provided in series between the connection terminal 113 and the collector of the transistor 103, and the resistor 108 is provided in series between the connection terminal 113 and an input of the diode 107, the low level side voltage of the notification signal and the low level side voltage of the communication signal can be set arbitrarily, so that the two signals can be superimposed on the shared signal line and connection terminal easily. Furthermore, an abnormal current flowing when an output-to-power-supply short circuit accident (supply fault) or an output-to-ground short circuit accident (ground fault) occurs on the signal line can be suppressed, and therefore breakage of a circuit element can be avoided; as a result, an element having a low rating can be used as the circuit element.

Note that in the above description, the control circuit 101 varies the Duty at which the transistor 103 is switched ON and OFF. However, the differentiation may also be performed with frequency variation, such that a frequency of the rectangular wave of the notification signal changes. Further, both the Duty and the frequency may be varied.

FIG. 2 shows a state in which the notification signal continues to be output while the communication signal is superimposed thereon. During communication, however, the notification signal may be stopped.

In the above description, the circuit configuration is set such that the amplitude of the notification signal is larger than the amplitude of the communication signal. However, the signals can also be differentiated easily with a circuit configuration in which the amplitude of the communication signal is larger than the amplitude of the notification signal.

### Embodiment 2

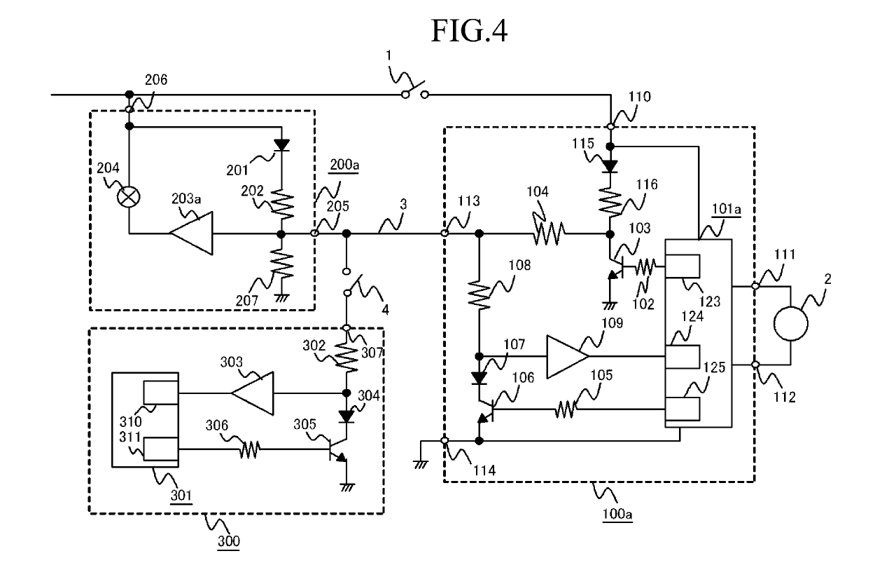

FIG. 4 is a circuit diagram showing a lighting apparatus 100a, an abnormality notification apparatus 200a, and the external communication apparatus 300 according to Embodiment 2, and connection relationships between these apparatuses. The lighting apparatus 100a and the abnormality notification apparatus 200a differ from their counterparts in FIG. 1 in that the apparatus 100a includes a control circuit 101a, a diode 115, and a resistor 116, and that the apparatus 200a includes a determination circuit 203a and a resistor 207. All other constitutions are identical and have been allocated identical reference numerals, and descriptions thereof will be omitted.

In the lighting apparatus 100a, the diode 115 and the resistor 116 are connected between the connection terminal 110 connected to the power supply and the transistor 103 and resistor 104. Hence, in FIG. 4, a current flows from the lighting apparatus 100a toward the abnormality notification apparatus 200a and the external communication apparatus 300.

In the abnormality notification apparatus 200a, the connection terminal 205 is grounded via the resistor 207, and therefore a voltage in the connection terminal 205 when an external apparatus is not connected to the connection terminal 205 corresponds to a voltage obtained by dividing the IG reference voltage by the resistors 202 and 207. Thus, a sufficient voltage difference for performing an abnormality determination (described below) can be generated.

In FIG. 2, the notification signal included in the input signal output from the lighting apparatus 100a includes more detailed information relating to the abnormal condition in the lighting apparatus 100a and light source 2. For example, the information includes: an output open condition in which no current flows to the light source 2, an output short condition in which an excessive current flows to the light source 2, and so on. The determination circuit 203a determines whether or not an abnormality has occurred on the basis of the input signal input therein, and lights the alarm lamp 204 when an abnormality has occurred.

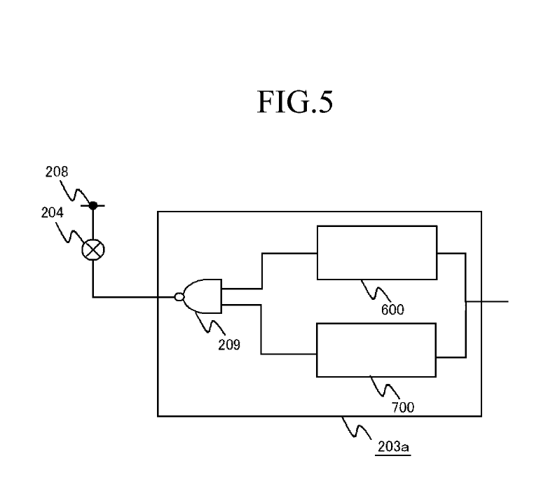

Next, a configuration of the determination circuit 203a provided in the abnormality notification apparatus 200a will be described using FIG. 5. FIG. 5 is a configuration diagram showing the configuration of the determination circuit 203a in the abnormality notification apparatus 200a. For the purpose of explanations, the alarm lamp 204 and an IG power supply 208 are described in the configuration of the abnormality notification apparatus 200a. Here, the IG power supply 208 expresses the connection terminal 206 as a power supply, assuming that power is supplied from the outside. In FIG. 5, the determination circuit 203a is constituted by a voltage level determination circuit 600, the rectangular wave determination circuit 700, and a NAND circuit 209.

An input signal output from the lighting apparatus 100a is input into the voltage level determination circuit 600 and the rectangular wave determination circuit 700, respectively, whereupon the voltage level determination circuit 600 outputs an abnormality determination signal to the NAND circuit 209 and the rectangular wave determination circuit 700 outputs a rectangular wave determination signal to the NAND circuit 209. The NAND circuit 209 outputs a determination signal on the basis of the input abnormality determination signal and rectangular wave determination signal. When the value of the determination signal is an L value, the alarm lamp 204 is lit, and when the value of the determination signal is an H value, the alarm lamp 204 is extinguished.

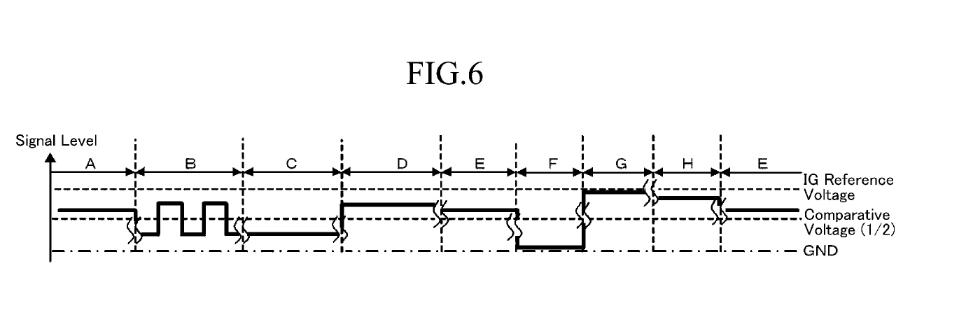

Next, a configuration and an operation of the voltage level determination circuit 600 will be described. The voltage level determination circuit 600 detects an abnormality by comparing the voltage of the notification signal with a power supply voltage. The voltage level determination circuit 600 of the abnormality notification apparatus 200a includes a comparator that inputs a voltage obtained by dividing the power supply voltage (the IG reference voltage) by a predetermined ratio into one terminal and inputs a signal line voltage into another input terminal. By comparing the signal (line) voltage with the divided voltage, the comparator detects output-to-power-supply short circuits, output-to-ground short circuits, connection failures in on-board devices, and so on. On the basis of the determination of the comparator, the voltage level determination circuit 600 generates a lighting pattern for lighting the alarm lamp based on the number of flashes or a flashing interval corresponding to the respective abnormalities, and outputs the generated lighting pattern as the abnormality determination signal. FIG. 6 is a view showing the content of the determination made by the voltage level determination circuit 600. The ordinate in the drawing shows the signal level. The IG reference voltage, a comparison voltage (½), and the GND value are shown on the ordinate as representative values.

When the power supply of the lighting apparatus 100a is OFF (region A) and when the input signal is determined to be a rectangular wave (region B), the voltage level determination circuit 600 does not perform the abnormality determination. When it is determined that the level of the input signal has reached a fixed level (regions C to H), the voltage level determination circuit 600 perform the abnormality determination.

When the voltage of the input signal is no less than ⅛ and no more than ⅜ of the IG reference voltage (region C), a unit abnormality in which the transistor 103 of the lighting circuit 100a remains permanently ON is determined to have occurred, and therefore a 5 Hz rectangular wave constituted by an L value (0 V) and an H value (5 V, for example) is output as the abnormality determination signal. When the voltage of the input signal is no less than 17/24 and no more than ⅞ of the IG reference voltage (region D), a unit abnormality in which the transistor 103 of the lighting circuit 100a remains permanently OFF is determined to have occurred, and therefore a 3 Hz rectangular wave constituted by an L value (0 V) and an H value (5 V, for example) is output as the abnormality determination signal. When the voltage of the input signal is no less than ⅜ and no more than 17/24 of the IG reference voltage (region E), it is determined that either the signal line 3 has been disconnected or the lighting apparatus 100a has not been connected, and therefore a 4 Hz rectangular wave constituted by an L value (0 V) and an H value (5 V, for example) is output as the abnormality determination signal. When the voltage of the input signal is no more than ⅛ of the IG reference voltage (region F), it is determined that the signal line 3 has short-circuited (grounded), and therefore a 6 Hz rectangular wave constituted by an L value (0 V) and an H value (5 V, for example) is output as the abnormality determination signal. When the voltage of the input signal is no less than 8/9 of the IG reference voltage (region G), it is determined that an output-to-power-supply short circuit (supply fault) has occurred on the signal line 3, and therefore a 1 Hz rectangular wave constituted by an L value (0 V) and an H value (5 V, for example) is output as the abnormality determination signal. When the voltage of the input signal is no less than ⅞ and no more than 8/9 of the IG reference voltage (region H), it is determined that the GND is Open, and therefore a 2 Hz rectangular wave constituted by an L value (0 V) and an H value (5 V, for example) is output as the abnormality determination signal. Note that the ratios of the IG reference voltage to the input signal cited in the above examples are values obtained when the resistor 202 is set at 1.5 kΩ, the resistor 207 is set at 3.3 kΩ, the resistor 104 is set at 560 kΩ, and the resistor 116 is set at 3.6 kΩ. When these parameters are modified, the ratios may be modified appropriately in accordance therewith. Further, the rectangular wave serving as the abnormality determination signal may take any waveform as long as the abnormalities can be differentiated.

The rectangular wave determination circuit 700 outputs an L value (0 V) when the condition of the lighting apparatus 100a is normal, and outputs an H value (5 V, for example) when an abnormality occurs. Hence, when an abnormality occurs in the condition of the lighting apparatus 100a such that the voltage level determination circuit 600 outputs the abnormality determination signal, an output of the NAND circuit 209 is a rectangular wave constituted by an H value and an L value corresponding to the abnormality determination signal. When an abnormality occurs in the condition of the lighting apparatus 100a but the voltage level determination circuit 600 does not output the abnormality determination signal or when the condition of the lighting apparatus 100a is normal, on the other hand, the NAND circuit 209 outputs an H value. When the output of the NAND circuit 209 is an L value, the alarm lamp 204 is lit, and when the output is an H value, the alarm lamp 204 is extinguished. Therefore, when the voltage level determination circuit 600 outputs the abnormality determination signal due to an abnormality in the condition of the lighting apparatus 100a, the alarm lamp 204 is caused to flash at a period corresponding to the content of the abnormality, and as a result, the driver can be notified of the content of the respective abnormalities.

As described above, the abnormality notification apparatus 200a according to this embodiment combines the abnormality determination output corresponding to each abnormality with the rectangular wave determination output to output a notification signal having a waveform that corresponds to the content of the abnormality in the light source 2, and notifies the driver of the various abnormalities by causing the alarm lamp 204 to flash when an abnormality occurs. As a result, an individual notification of the abnormal conditions occurring in the lighting system can be provided, thereby encouraging swift repair.

Further, by outputting a rectangular wave steadily when the lit light source 2 is lit normally and stopping output of the rectangular wave when an abnormality occurs, the output of the rectangular wave is stopped in the same manner as the case where the light source 2 operates abnormally when a CPU in the control circuit 101a stops operating or a signal output element (the transistor 103) is disabled, and therefore the abnormality notification apparatus 200a can detect both an abnormality in the light source 2 and an abnormality in the lighting apparatus 100a. Hence, even when an abnormality occurs in the lighting apparatus 100a, the notification (display) of the abnormal operation can be provided, and therefore the driver can be informed that the headlamps are abnormally lit. As a result, dangerous situations arising from abnormal lighting of the headlamps can be avoided and swift repair can be encouraged.

### Embodiment 3

In Embodiment 1, the two signals are differentiated by setting the signal level of the communication signal to be lower than the signal level of the notification signal, but the two signals may be differentiated by conversely setting the signal level of the communication signal to be higher than the signal level of the notification signal. A headlamp lighting system in which the signal level of the communication signal is high will be described below.

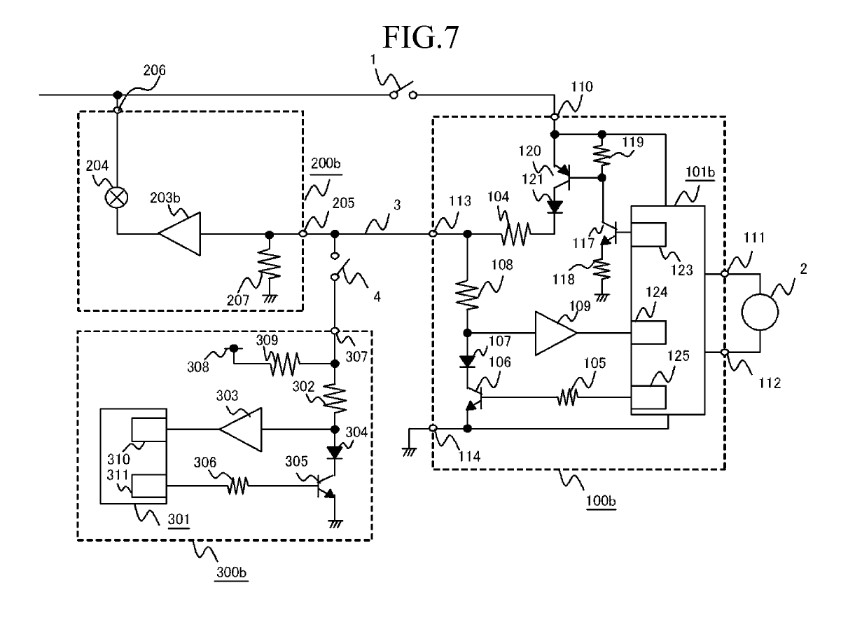

FIG. 7 is a circuit diagram showing a lighting apparatus 100b, an abnormality notification apparatus 200b, and an external communication apparatus 300b according to Embodiment 3, and connection relationships between these apparatuses. Identical constitutions to those shown in FIG. 4 have been allocated identical reference symbols, and descriptions thereof will be omitted. In FIG. 4, signal output is realized by disposing the NPN transistor 103 on an L (GND) side of the lighting apparatus 100a, whereas in FIG. 7, signal output is realized by disposing a PNP transistor 120 on an H (power supply) side of the lighting apparatus 100b.

In the lighting apparatus 100b, the alarm output unit 123 of a control circuit 101b is connected to a base of a transistor 117 to switch ON and OFF of the transistor 117 by outputting a rectangular wave constituted by 0 V and 5 V. An emitter of the transistor 117 is grounded via a resistor 118, while a collector is connected to a base of a transistor 120 and connected to the connection terminal 110 via a resistor 119. A collector of the transistor 120 is connected to the connection terminal 110, and an emitter is connected to the connection terminal 113 via a diode 121 and the resistor 104. By switching ON and OFF of the transistor 117, the transistor 120 is switched ON and OFF, and therefore a voltage change generated by switching ON and OFF of the transistor 120 is output as the notification signal.

The external communication apparatus 300b includes a pull-up resistor 309 and a power supply 308 connected to the connection terminal 307 via the resistor 309. When the connection SW 4 is switched ON, the connection terminal 113 of the lighting apparatus 100b is connected to the power supply 308 via the signal line 3, the connection terminal 307, and the resistor 309, and as a result, the voltage of the connection terminal 113 rises to the vicinity of a voltage of the power supply 308.

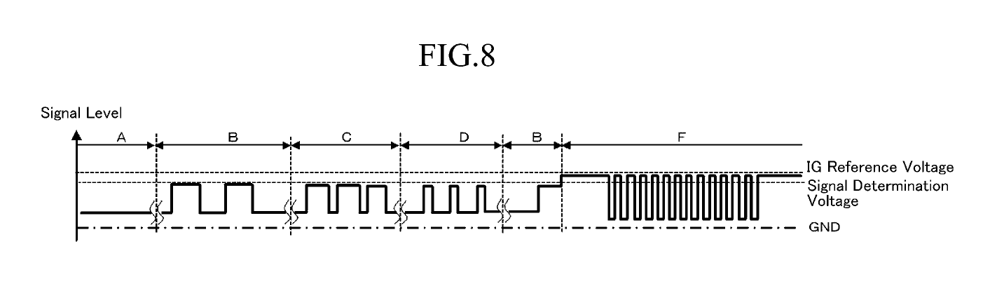

FIG. 8 is a waveform diagram showing levels of an output signal of the lighting apparatus 100b. Parts that are identical to or correspond to the parts shown in FIG. 2 have been allocated identical reference symbols, and descriptions thereof will be omitted.

The output signal level is similar to FIG. 2 up to the point at which the connection SW 4 is switched ON such that the external communication apparatus 300b is connected to the signal line 3 (regions A to D). When the connection SW 4 is switched ON and the external communication apparatus 300b is connected to the signal line 3, the communication signal level rises to the vicinity of the IG reference voltage. Further, to prevent an excessive current from being generated in the lighting apparatus 100b, the transistor 120 of the lighting apparatus 100b is switched OFF, whereby the notification signal is stopped. When the transistor 106 is switched ON in accordance with the output of the transmission unit 125 of the control circuit 101b, the connection terminal 113 is grounded via the resistor 108 and the diode 107, whereby the output signal level falls to the vicinity of GND. Hence, the output signal falls to the vicinity of GND when the transistor 106 is ON and rises to the vicinity of the IG reference voltage when the transistor 106 is OFF (region F).

In this manner, by setting the signal level of the communication signal to be higher than the signal level of the notification signal, the signals can be differentiated easily. Furthermore, the signal level of the notification signal is set to fall to or below ⅔ of the IG reference voltage (the signal identification voltage) in a condition, for example, where the connection SW 4 is OFF and the external communication apparatus 300b is disconnected, and the level of the communication signal is set to take a higher value than ⅔ of the IG reference voltage (the signal identification voltage) in a condition where the connection SW 4 is ON and the external communication apparatus 300b is connected. Thus, the lighting apparatus 100b can determine that the external communication apparatus 300b is connected by detecting that the voltage of the connection terminal 113 is equal to or greater than ⅔ of the IG reference voltage (the signal identification voltage), and can therefore start a response to the communication operation.

In this embodiment, as described above, the signal level of the communication signal is set to be higher than the signal level of the notification signal, and therefore the two signals can be identified easily in the lighting apparatus 100b, the abnormality notification apparatus 200b, and the external communication apparatus 300b even though the connection terminal 113 is used for both communication and abnormality notification.

Further, by setting a high level side voltage of the communication signal at a higher voltage than a high level side voltage of the notification signal, the connection of the external communication apparatus 300b can be determined.

Furthermore, by providing the pull-up resistor 309 in the external communication apparatus 300b, the high level side voltage of the notification signal and the high level side voltage of the communication signal can be set arbitrarily, and therefore the signal levels of the two signals can be set easily.

When the transistors 106 and 120 of the lighting apparatus 100b are switched ON simultaneously while the external communication apparatus 300b is connected, an excessive current flows to the lighting apparatus 100b. However, the lighting apparatus 100b is set to switch the transistor 120 OFF when the external communication apparatus 300b is connected so that output of the notification signal is stopped. By switching between output of the notification signal and output of the communication signal using the control circuit 101b serving as a switching unit in this manner, the generation of an excessive current can be prevented. Note that this switch is performed when a large increase in the voltage of the connection terminal 113 is detected, for example.

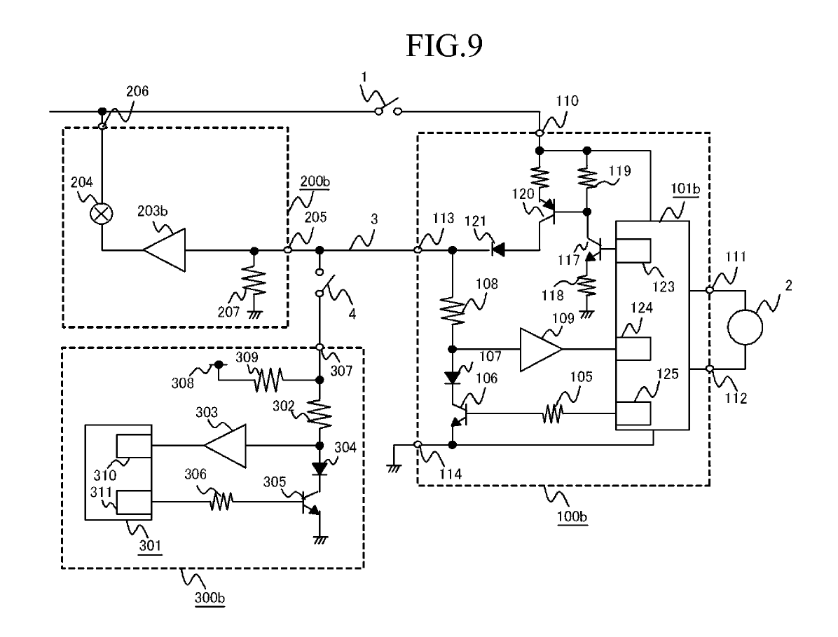

Note that the lighting apparatus 100b may have a constant current output circuit configuration, as shown in FIG. 9. By setting the pull-up resistor 309 in this type of circuit configuration such that a current exceeding a set constant current flows through the pull-up resistor 309, the high level side voltage of the communication signal can be set at a higher voltage than the high level side voltage of the notification signal in the resistor 207, through which the constant current flows, leading to a fixed voltage reduction, when the external communication apparatus 300b is connected thereto.

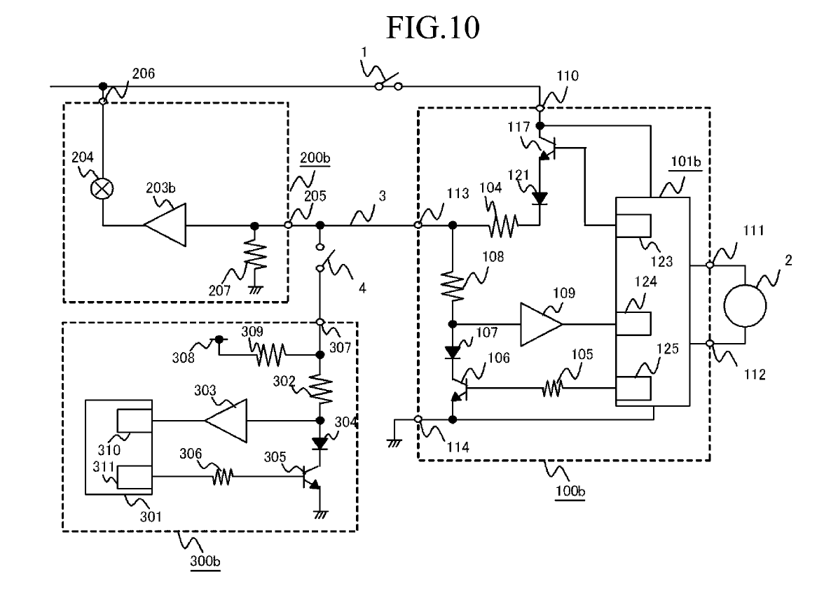

Further, the lighting apparatus 100b may have a constant voltage output circuit configuration, as shown in FIG. 10. By setting the pull-up resistor 309 in this type of circuit configuration such that a voltage exceeding an output constant voltage flows through the pull-up resistor 309, the high level side voltage of the communication signal can be set at a higher voltage than the high level side voltage of the notification signal in the resistor 207, to which the constant voltage is applied, when the external communication apparatus 300b is connected thereto.

Note that in the above description, the circuit configuration is formed such that the amplitude of the notification signal is greater than the amplitude of the communication signal. However, the signals can be identified easily in a circuit configuration formed such that the amplitude of the communication signal is conversely larger than the amplitude of the notification signal.

### Embodiment 4

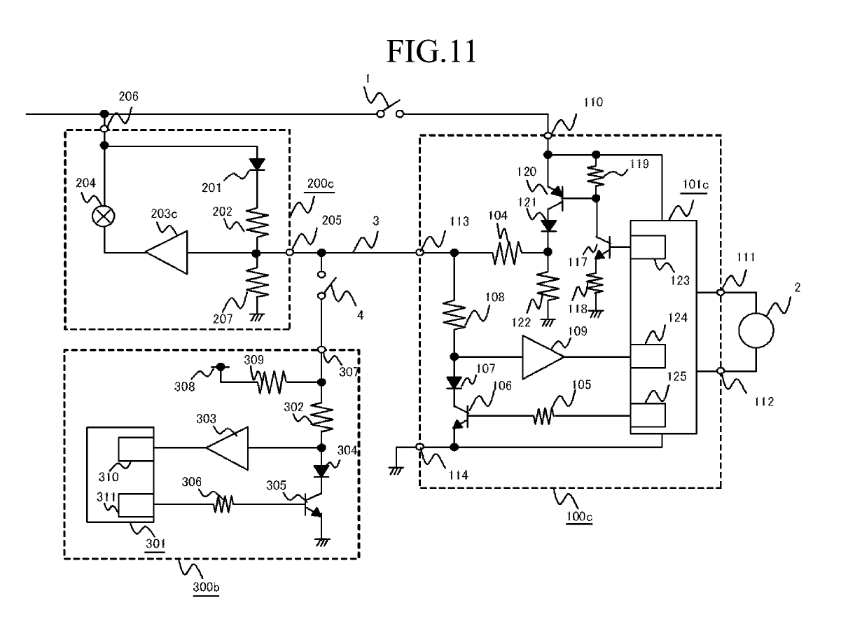

FIG. 11 is a circuit diagram showing a lighting apparatus 100c, an abnormality notification apparatus 200c, and an external communication apparatus 300b according to Embodiment 4, and connection relationships between these apparatuses. The lighting apparatus 100c and the abnormality notification apparatus 200c differ from their counterparts in FIG. 7 in that the apparatus 100c includes a resistor 122, and the apparatus 200c includes a determination circuit 203c, the diode 201, and the resistor 202. All other constitutions are identical and have been allocated identical reference numerals, and descriptions thereof will be omitted.

In the abnormality notification apparatus 200c, the connection terminal 205 is connected to a battery via the resistor 202 and the diode 201, and in the lighting apparatus 100c, a midpoint between the resistor 104 and the diode 121 is grounded via the resistor 122. Thus, a sufficient voltage difference for performing an abnormality determination in the determination circuit 203c can be generated.

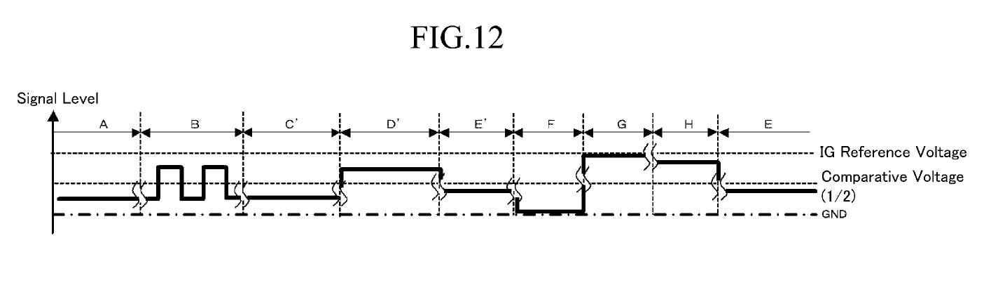

The determination circuit 203c of the abnormality notification apparatus 200c is constituted by a voltage level determination circuit 600c, the rectangular wave determination circuit 700, and the NAND circuit 209. The voltage level determination circuit 600c differs from the voltage level determination circuit 600a in the content of the determination performed therein. FIG. 12 is a view showing the determination content of the voltage level determination circuit 600c. Parts that are identical to or correspond to the parts shown in FIG. 6 have been allocated identical reference symbols, and descriptions thereof will be omitted.

When the voltage of the input signal is no less than ⅛ and no more than ⅜ of the IG reference voltage (region C′), a unit abnormality in which the transistor 120 of the lighting circuit 100c remains permanently OFF is determined to have occurred, and therefore a 5 Hz rectangular wave constituted by an L value (0 V) and an H value (5 V, for example) is output as the abnormality determination signal. When the voltage of the input signal is no less than 17/24 and no more than ⅞ of the IG reference voltage (region D′), a unit abnormality in which the transistor 120 of the lighting circuit 100c remains permanently ON is determined to have occurred, and therefore a 3 Hz rectangular wave constituted by an L value (0 V) and an H value (5 V, for example) is output as the abnormality determination signal. When the voltage of the input signal is no less than ⅜ and no more than 17/24 of the IG reference voltage (region E′), it is determined that either the signal line 3 has been disconnected or the lighting apparatus 100c has not been connected, and therefore a 4 Hz rectangular wave constituted by an L value (0 V) and an H value (5 V, for example) is output as the abnormality determination signal. All other determinations are similar to those performed by the voltage level determination circuit 600a. Note that the ratios of the IG reference voltage to the input signal cited in the above examples are values obtained when the resistor 202 is set at 3.3 kΩ, the resistor 207 is set at 1.5 kΩ, the resistor 104 is set at 560Ω, and the resistor 122 is set at 3.6 kΩ. When these parameters are modified, the ratios may be modified appropriately in accordance therewith. Further, the rectangular wave serving as the abnormality determination signal may take any waveform as long as the respective abnormalities can be differentiated.

As described above, the abnormality notification apparatus 200c according to this embodiment combines the abnormality determination output corresponding to each abnormality with the rectangular wave determination output in order to output a notification signal having a waveform that corresponds to the content of the abnormality in the light source 2, and notifies the driver of the various abnormalities by causing the alarm lamp 204 to flash when an abnormality occurs. As a result, individual notification of the respective abnormal conditions occurring in the lighting system can be provided, and therefore swift repair can be encouraged.

As the light source 2 of Embodiments 1 to 4, a halogen lamp, a discharge lamp such as a HID (High Intensity Discharge) lamp, an LED (Light Emitting Diode), and so on may be used.

In Embodiments 1 to 4, the signal line used when the external communication apparatus is connected to the lighting apparatus is not limited only to the signal line 3 connecting the lighting apparatus to the abnormality notification apparatus, and the external communication apparatus may be connected to the lighting apparatus by a separate signal line instead of the signal line 3.

In Embodiments 1 to 4, the abnormality notification signal and the communication signal can be differentiated from each other by varying the respective voltage levels of the signals, but the signals may be differentiated by varying the respective frequencies, Duties, and so on thereof. The abnormality notification signal and the communication signal can be differentiated from each other as long as the signals have different signal forms.

Note that in the above description, the connection SW 4 is provided to connect the abnormality notification apparatus 200 and so on, the external communication apparatus 300 and so on, and the lighting apparatus 100 and so on, but the functions of the respective apparatuses may be activated in a combination of the lighting apparatus 100 and so on and the abnormality notification apparatus 200 and so on or a combination of the lighting apparatus 100 and so on and the external communication apparatus 300 and so on. Further, the connecting and disconnecting operations performed by the connection switch may be replaced by insertion and removal operations of a connection connector provided in the external communication apparatus 300 and so on.

Note that in the above description, one end of the signal line 3 is connected to the connection terminal 113 of the lighting apparatus 100 and so on while the other end is divided into two and connected to the connection terminal 205 of the abnormality notification apparatus 200 and so on and the connection switch SW 4. Thus, a part of both of a signal line for connecting the abnormality notification apparatus 200 and so on and the lighting apparatus 100 and so on and a signal line for connecting the external communication apparatus 300 and so on and the lighting apparatus 100 and so on can be realized by a shared signal line. However, separate signal lines may be provided. More specifically, when the external communication apparatus 300 and so on is connected to the lighting apparatus 100 and so on, a signal line connecting the abnormality notification apparatus 200 and so on to the lighting apparatus 100 and so on may be removed from the connection terminal 113 and a separate signal line connected to the connection terminal 307 of the external communication apparatus 300 and so on may be attached to the connection terminal 113 of the lighting apparatus 100 and so on in place of the removed signal line.

Note that in the above description, an inspection apparatus was cited as an example of the external communication apparatus 300 and so on, but the external communication apparatus 300 and so on may be an in-vehicle control apparatus for controlling a vehicle-installed device, such as a control apparatus having a function for instructing a lighting apparatus through communication to perform dimmed lighting on a DRL as a function for controlling lighting of an in-vehicle lamp such as a headlamp, for example.

### EXPLANATION OF REFERENCE NUMERALS

100, 100a, 100b, 100c: lighting apparatus
101, 101a, 101b, 101c: control circuit
200, 200a, 200b, 200c: abnormality notification apparatus
203, 203a, 203b, 203c: determination circuit
300, 300b: external communication apparatus

1. A headlamp light source lighting apparatus for lighting a light source of a headlamp, comprising:
a notification signal output unit for outputting a notification signal relating to a condition of the light source and/or a condition of the light source lighting apparatus to a first apparatus; and
a communication signal input/output unit for transmitting a communication signal having a different signal form to the notification signal to a second apparatus that is different to the first apparatus, and receiving the communication signal from the second apparatus,
wherein a connection terminal of a signal line connected to the first apparatus and the second apparatus is shared.

2. The headlamp light source lighting apparatus according to claim 1, wherein the first apparatus is a condition notification apparatus for notifying a driver of the condition of the light source and/or the light source lighting apparatus.

3. The headlamp light source lighting apparatus according to claim 1, wherein the second apparatus is an inspection apparatus that is connected during an inspection of the headlamp light source lighting apparatus.

4. The headlamp light source lighting apparatus according to claim 1, wherein the second apparatus is an in-vehicle control apparatus connected to the headlamp light source lighting apparatus.

5. The headlamp light source lighting apparatus according to claim 1, wherein the communication signal includes lighting control information relating to the light source and/or information relating to the condition of the light source.

6. The headlamp light source lighting apparatus according to claim 1, wherein the notification signal output unit continuously outputs the notification signal having a predetermined signal waveform, when the light source and/or the headlamp light source lighting apparatus is normal.

7. The headlamp light source lighting apparatus according to claim 6, wherein the notification signal is a rectangular wave, and
the notification signal output unit varies a period and/or a duty of the notification signal in accordance with an abnormality in the light source and/or the headlamp light source lighting apparatus.

8. The headlamp light source lighting apparatus according to claim 1, further comprising a communication signal input unit for identifying the notification signal output to the first apparatus and the communication signal from the second apparatus that is input via the connection terminal.

9. The headlamp light source lighting apparatus according to claim 1, wherein a signal voltage of the notification signal and a signal voltage of the communication signal are set at different voltages.

10. The headlamp light source lighting apparatus according to claim 9, wherein the notification signal and the communication signal are rectangular waves, and
a low level side voltage of a rectangular wave of the notification signal is a higher voltage than a low level side voltage of a rectangular wave of the communication signal.

11. The headlamp light source lighting apparatus according to claim 9, wherein the notification signal and the communication signal are rectangular waves, and
a high level side voltage of a rectangular wave of the notification signal is a lower voltage than a high level side voltage of a rectangular wave of the communication signal.

12. The headlamp light source lighting apparatus according to claim 10, wherein the notification signal output unit includes a first resistor connected in series to the connection terminal, and
the communication signal output unit includes a second resistor connected in series to the connection terminal.

13. The headlamp light source lighting apparatus according to claim 11, wherein the notification signal output unit includes a first resistor connected in series to the connection terminal, and
the communication signal output unit includes a second resistor connected in series to the connection terminal.

14. The headlamp light source lighting apparatus according to claim 1, wherein a control operation is performed in accordance with the communication signal from the second apparatus that is input via the connection terminal.

15. (canceled)

16. A communication apparatus comprising:
a connection terminal into which a communication signal output by a headlamp light source lighting apparatus for lighting a light source of a headlamp is input via a signal line;
a communication signal output unit for outputting a communication signal including lighting control information relating to the light source and/or information relating to a condition of the light source to the headlamp light source lighting apparatus;
a communication signal input unit for inputting a communication signal including the lighting control information relating to the light source and/or the information relating to the condition of the light source that is output from the headlamp light source lighting apparatus;
a notification unit for notifying an inspector of information including the lighting control information relating to the light source and/or the information relating to the condition of the light source; and
an operating unit for storing or setting the information including the lighting control information relating to the light source and/or the information relating to the condition of the light source in the headlamp light source lighting apparatus via the communication signal output from the communication signal output unit.
